(19) United States
(12) Patent Application Publication
(10) Pub. No.: US 2006/0103361 A1
(43) Pub. Date: May 18, 2006

(54) Linear voltage regulator

(75) Inventors: Wu Jiang, Shenzhen (CN); Yong-Zhao Huang, Shenzhen (CN); Yun Li, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/283,287

(22) Filed: Nov. 17, 2005

(30) Foreign Application Priority Data
Nov. 18, 2004 (CN) 200410052366.X

(51) Int. Cl. G05F 1/56

(52) U.S. Cl. 323/273

(57) ABSTRACT

A linear voltage regulator provides a regulated load voltage to a load. In a preferred embodiment, the linear voltage regulator includes: a regulating circuit for receiving an input voltage and providing an output voltage to a load, the regulating circuit being driven by a driving voltage; and two resistors connected to each other in series receiving the output voltage and providing an adjusting current to the regulating circuit. The linear voltage regulator is capable of providing a greater current to the load, and having a wide range of input voltages.

### BACKGROUND OF THE INVENTION

1. Field of the Invention

The present invention relates to voltage regulators, and particularly to a linear voltage regulator for providing a regulated voltage to a load mounted on a motherboard.

2. General Background

Linear voltage regulators are widely used to supply power to electronic devices, such as to a load on a motherboard of a computer. Such linear voltage regulators are available in a wide variety of configurations for many different applications.

Referring to FIG. 3, a typical linear voltage regulator 1 includes a voltage regulator IC (Integrated Circuit) 10. The voltage regulator IC 10 includes an adjusting terminal 11, an input terminal 12, and an output terminal 13. The adjusting terminal 11 receives an adjusting voltage V₁. The input terminal 12 receives an input voltage Vᵢₙ, and is grounded via a first filter capacitor C₁. The output terminal 13 provides an output voltage Vₒᵤₜ to a load R_{L}, and is grounded via a second filter capacitor C₂. Two resistors R₁ and R₂ are connected to each other in series, between the output terminal 13 and ground. A node N between the resistors R₁ and R₂ provides the adjusting voltage V₁ to the adjusting terminal 11.

An impedance of each of the resistors R₁, R₂ is adjustable. When the resistor R₁ or the resistor R₂ has an appropriate impedance, the output voltage Vₒᵤₜ can be regulated at a required level.

However, in the voltage regulator IC 10, when the input voltage Vᵢₙ is 3.3V and the output voltage Vₒᵤₜ is 1.5V, a load current is less than 0.1 A. Therefore the linear voltage regulator 1 cannot provide a greater current to the load. Furthermore, in the voltage regulator IC 10, a difference between the input voltage Vᵢₙ and the output voltage Vₒᵤₜ is between 1.3V and 1.5V. Therefore when a 1.5V output voltage Vₒᵤₜ is needed, the input voltage Vᵢₙ must be between 2.8V (i.e., 1.5V+1.3V) and 3.0V (i.e., 1.5V+1.5V). Otherwise, the linear voltage regulator 1 will not run properly.

What is needed, therefore, is a linear voltage regulator which is able to provide a greater current to a load and have a wide range of input voltages.

### SUMMARY

A linear voltage regulator is provided for providing a regulated load voltage to a load. In a preferred embodiment, the linear voltage regulator includes: a regulating circuit for receiving an input voltage and providing an output voltage to a load, the regulating circuit being driven by a driving voltage; and two resistors connected to each other in series receiving the output voltage and providing an adjusting current to the regulating circuit. Since a MOSFET is adopted as a regulating means, the load current of the linear voltage regulator is much higher than that of the conventional linear voltage regulator. Due to the regulating means being driven by the driving voltage, the output voltage is independent of the input voltage. Therefore the output voltage is stabilized at about 1.5V when the input voltage is varying within a wide range between about 1.5V and 7.0V.

The linear voltage regulator is capable of providing a greater current to the load, and having a wide range of input voltages.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram of a linear voltage regulator of a first preferred embodiment of the present invention;

FIG. 2 is a circuit diagram of a linear voltage regulator of a second preferred embodiment of the present invention; and

FIG. 3 is a circuit diagram of a typical linear voltage regulator.

### DETAILED DESCRIPTION OF THE EMBODIMENTS

As shown in FIG. 1, in a first preferred embodiment of the present invention, a linear voltage regulator 2 includes a regulating circuit 20. The regulating circuit 20 includes an adjusting terminal 21, an input terminal 22, and an output terminal 23. The adjusting terminal 21 receives an adjusting current I₁. The input terminal 22 receives an input voltage Vᵢₙ. The output terminal 23 provides an output voltage Vₒᵤₜ to a load R_{load}. A resistive voltage divider (not labeled) comprises two resistors R₄ and R₅. The resistors R₄ and R₅ are connected to each other in series, between the output terminal 23 and ground. A node M between the resistor R₄ and the resistor R₅ provides the adjusting current I₁.

The regulating circuit 20 includes a regulating means 201, a transistor amplifier 203, and a current-limiting resistor R₃. The regulating means 201 is an N-channel metal-oxide-semiconductor field-effect transistor (MOSFET). The transistor amplifier 203 is a bipolar transistor. A base of the transistor amplifier 203 receives the adjusting current I₁. An emitter of the transistor amplifier 203 is grounded. A collector of the transistor amplifier 203 is connected to a gate of the regulating means 201. The gate of the regulating means 201 as a controlling pole is coupled to a driving voltage V_{d} via a current-limiting resistor R₃. A drain of the regulating means 201 as an input pole is connected to the input terminal 22 for receiving the input voltage Vᵢₙ. A source of the regulating means 201 as an output pole is connected to the output terminal 23 for providing the output voltage Vₒᵤₜ.

When an output voltage Vₒᵤₜ suddenly becomes higher, the adjusting current I₁ becomes larger correspondingly. A collector current I₂ becomes larger correspondingly. Then a voltage Δ U_{DG} between the gate and the source of the regulating means 201 becomes higher. The increase of the voltage Δ U_{GS} induces a decrease of the output voltage Vₒᵤₜ. Therefore the load voltage V_{load} drops to a same level as before the sudden increase thereof.

Contrarily, when the output voltage Vₒᵤₜ suddenly becomes lower, the adjusting current I₁ becomes smaller correspondingly. The collector current I₂ becomes smaller correspondingly. Then the voltage U_{DG} between the gate and the source of the regulating means 201 becomes lower. The decrease of the voltage Δ U_{DG} induces an increase of the output voltage Vₒᵤₜ. Therefore the load voltage V_{load} climbs to a same level as before the sudden decrease thereof.

In the illustrated embodiment, because that the regulating means 201 is driven by the driving voltage V_{d} instead of the input voltage Vᵢₙ, a change of the input voltage Vᵢₙ cannot influence the conduction capability of the regulating means 201. Therefore the linear voltage regulator 2 can have a wide range of the input voltage Vᵢₙ. Because the regulating means 201 can have a greater current, the linear voltage regulator 2 can provide a greater current. Furthermore, since the input voltage Vᵢₙ can be reduced, a power of the linear voltage regulator 2 can be reduced correspondingly.

A relationship of an impedance of the load R_{load}, the input voltage Vᵢₙ and the output voltage Vₒᵤₜ is shown as follows:

1) When the input voltage Vᵢₙ and the driving voltage V_{d} are invariable. As an example, the input voltage Vᵢₙ is 3.3V, and the driving voltage V_{d} is 3.3V. In such case, a relationship of the impedance of the load R_{load} and the output voltage Vₒᵤₜ is shown as follows:

TABLE 1
Relationship between Impedance of Load and Output Voltage

| Impedance of load R_{load} (Ω) | Output voltage Vₒᵤₜ (V) |
|---|---|
| . . . | . . . |
| 8.5 | 1.508 |
| 12.3 | 1.514 |
| 13.2 | 1.515 |
| 15.3 | 1.515 |
| 19.2 | 1.517 |
| 19.7 | 1.518 |
| 24.6 | 1.519 |
| 29.7 | 1.521 |
| 30.5 | 1.522 |
| 38.6 | 1.523 |
| 43.6 | 1.525 |
| 47.5 | 1.525 |
| 52.8 | 1.526 |
| 58.1 | 1.526 |
| 61.4 | 1.526 |
| . . . | . . . |

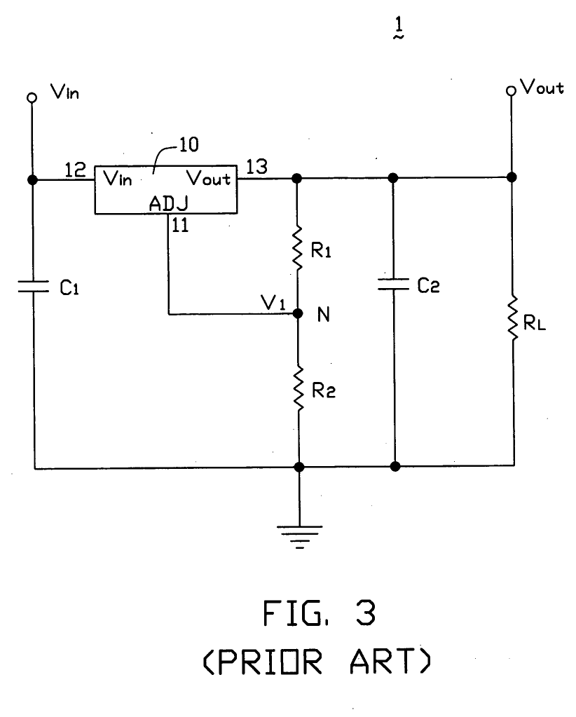

As seen in TABLE 1, the output voltage Vₒᵤₜ is stabilized at about 1.5V. Furthermore, since a MOSFET is adopted as the regulating means 201, a 5.2 A load current I_{load} is gained. Compare this with the conventional linear voltage regulator 1 (see FIG. 3), wherein when the input voltage Vᵢₙ is 3.3V and the output voltage Vₒᵤₜ is stabilized at about 1.5V, the load current I_{load} is less than 0.1 A. The load current I_{load} of the linear voltage regulator 2 is as much as 52 times (or more) higher than that of the conventional linear voltage regulator 1.

2) When the impedance of the load R_{load} and the driving voltage V_{d} are invariable. As an example, the impedance of the load R_{load} is 100 Ω, and the driving voltage V_{d} is 3.3V. In such case, a relationship of the input voltage Vᵢₙ and the output voltage Vₒᵤₜ is shown as follows:

TABLE 2
Relationship between Input Voltage and Output Voltage

| Input voltage Vᵢₙ (V) | Output voltage Vₒᵤₜ (V) |
|---|---|
| . . . | . . . |
| 1.505 | 1.488 |
| 1.6 | 1.512 |
| 1.7 | 1.512 |
| 1.8 | 1.512 |
| 2 | 1.512 |
| 2.5 | 1.512 |
| 3 | 1.512 |
| 3.6 | 1.512 |
| 3.8 | 1.512 |
| 4 | 1.513 |
| 4.8 | 1.513 |
| 5.7 | 1.513 |
| 6.2 | 1.513 |
| 6.7 | 1.513 |
| 7 | 1.513 |
| . . . | . . . |

As seen in TABLE 2, due to the regulating means 201 being driven by the driving voltage V_{d}, the output voltage Vₒᵤₜ is independent of the input voltage Vᵢₙ. Therefore the output voltage Vₒᵤₜ is stabilized at about 1.5V when the input voltage Vᵢₙ is varying within a wide range between about 1.5V and 7.0V.

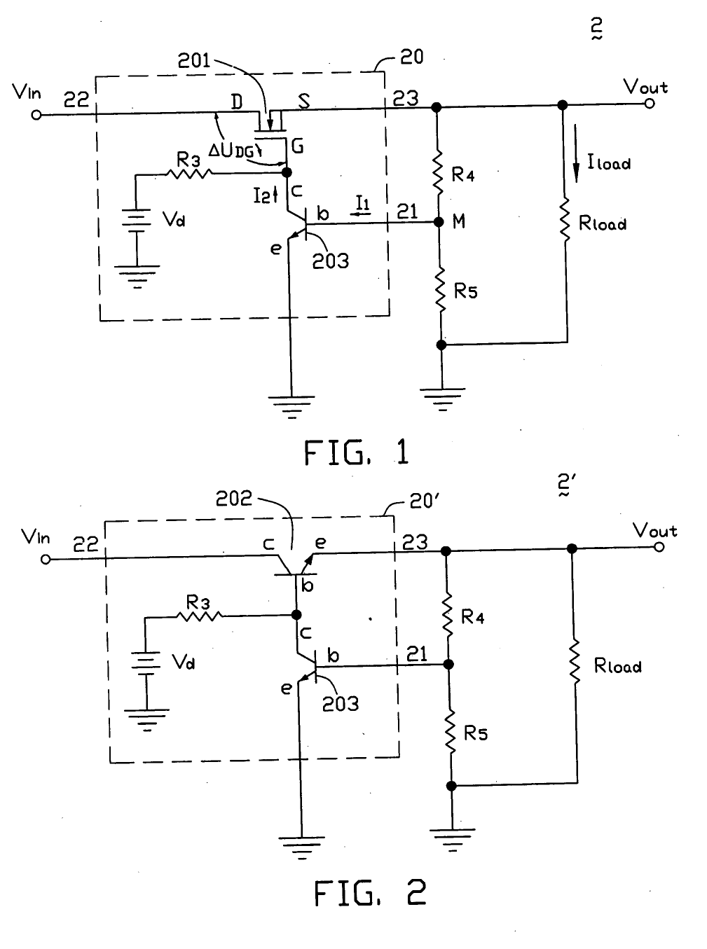

As shown in FIG. 2, in a second preferred embodiment of the present invention, instead of having a regulating circuit 20, a linear voltage regulator 2′ of the second preferred embodiment has a regulating circuit 20′. The regulating circuit 20′ includes a regulating means 202. The regulating means 202 is a bipolar transistor. A base of the regulating means 202 as a controlling pole is connected to the transistor amplifier 203, and receives the driving voltage V_{d}. A collector of the regulating means 202 as an input pole is connected to the input terminal 22 for receiving the input voltage Vᵢₙ. An emitter of the regulating means 202 as an output pole is connected to the output terminal 23 for providing the output voltage Vₒᵤₜ.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A linear voltage regulator comprising:
a regulating circuit for receiving an input voltage and providing an output voltage to a load, the regulating circuit being adapted to be driven by a driving voltage; and
two resistors connected to each other in series for receiving the output voltage and providing an adjusting current to the regulating circuit.

2. The linear voltage regulator as claimed in claim 1, wherein the regulating circuit comprises an input terminal, an output terminal and an adjusting terminal, the input terminal receives the input voltage, the output terminal provides the output voltage to the load, the resistors are connected between the output terminal and ground, and a node between the resistors provides the adjusting current to the adjusting terminal.

3. The linear voltage regulator as claimed in claim 2, wherein the regulating circuit includes a regulating means and a transistor amplifier, the regulating means includes a controlling pole, an input pole and an output pole, the transistor amplifier is a bipolar transistor, a base of the transistor amplifier receives the adjusting current, an emitter of the transistor amplifier is grounded, a collector of the transistor amplifier is connected to the controlling pole, the controlling pole receives the driving voltage, the input pole is connected to the input terminal for receiving the input voltage, and the output pole is connected to the output terminal for providing the output voltage.

4. The linear voltage regulator as claimed in claim 3, wherein the regulating means is a MOSFET (metal-oxide-semiconductor field-effect transistor), the controlling pole is a gate of the regulating means, the input pole is a drain of the regulating means, and the output pole is a source of the regulating means.

5. The linear voltage regulator as claimed in claim 3, wherein the regulating means is a bipolar transistor, the controlling pole is a base of the regulating means, the input pole is a collector of the regulating means, and the output pole is an emitter of the regulating means.

6. The linear voltage regulator as claimed in claim 1, wherein the input voltage is 3.3V.

7. The linear voltage regulator as claimed in claim 1, wherein the output voltage is 1.5V.

8. A linear voltage regulator comprising:
a regulating means comprising a controlling pole, an input pole and an output pole, the controlling pole receiving a driving voltage, the input pole receiving an input voltage, the output pole providing an output voltage;
a transistor amplifier including a base receiving an adjusting current, an emitter being grounded, and a collector being connected to the controlling pole; and
a resistive voltage divider receiving the output voltage and providing the adjusting current to the base.

9. The linear voltage regulator as claimed in claim 8, wherein the resistive voltage divider comprises two resistors, the resistors are connected to each other in series between the output pole and ground, and a node between the resistors provides the adjusting current to the base.

10. The linear voltage regulator as claimed in claim 8, wherein the regulating means is an N-channel MOSFET (metal-oxide-semiconductor field-effect transistor), the controlling pole is a gate of the regulating means, the input pole is a drain of the regulating means, and the output pole is a source of the regulating means.

11. The linear voltage regulator as claimed in claim 8, wherein the regulating means is a bipolar transistor, the controlling pole is a base of the regulating means, the input pole is a collector of the regulating means, and the output pole is an emitter of the regulating means.

12. The linear voltage regulator as claimed in claim 8, wherein the input voltage is 3.3V.

13. The linear voltage regulator as claimed in claim 8, wherein the output voltage is 1.5V.

14. A voltage regulator comprising:
a regulating means capable of accepting an input voltage and generating an output voltage under control of a driving voltage independent from said input voltage;
an amplifier electrically connected with said regulating means and capable of accepting an electrical current caused by said output voltage of said regulating means so as to control said regulating means together with said driving voltage.

15. The voltage regulator as claimed in claim 14, wherein said regulating means is a selective one of a metal-oxide-semiconductor field-effect transistor (MOSFET) and a bipolar transistor.

16. The voltage regulator as claimed in claim 14, further comprising a voltage divider electrically connected between said regulating means and amplifier so as to generate said electrical current for said amplifier based on said output voltage of said regulating means.
